(19) United States
(12) Patent Application Publication
(10) Pub. No.: US 2005/0157889 A1
(43) Pub. Date: Jul. 21, 2005

(54) Electronic device with external speaker

(75) Inventor: Yoshikazu Yonezu, Takefu-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Takefu-city (JP)

(21) Appl. No.: 11/036,999

(22) Filed: Jan. 19, 2005

(30) Foreign Application Priority Data
Jan. 19, 2004 (JP) 2004-010356

(51) Int. Cl. H04B 3/00; H04R 5/02

(52) U.S. Cl. 381/77; 381/306

(57) ABSTRACT

The present invention provides an electronic device with external speaker in which the speaker can be readily attached/detached and loose connection can be prevented even when the speaker is attached/detached repeatedly.

A locking hook 33 of an external speaker 30 is inserted into a locking hole 16 of a cabinet 11, and a connecting terminal 37 provided in the cabinet 11 is inserted into a connecting jack 20 provided in the external speaker 30. The connecting jack 20 is pressed by the biasing force of a spring 23 serving as an biasing means, and is held on a position engaged to the connecting terminal 37. Then, the external speaker 30 is moved by sliding to lock the locking hook 33 into the locking hole 16. At this point, the connecting jack 20 moves along the moving direction of the external speaker 30 against the spring 23. Hence, it is possible to connect a connector pin 38 of the connecting terminal 37 without interfering with the sliding movement of the external speaker 30.

The present application is based on and claims priority of Japanese patent application No. 2004-010356 filed on Jan. 19, 2004, the entire contents of which are hereby incorporated by reference.

### BACKGROUND OF THE INVENTION

1. Field of the Invention

The present invention relates to an electronic device with external speakers, and particularly to a television receiver or a display of a computer which can be detachably mounted outside the electronic device.

2. Description of the Related Art

Conventionally, electronic devices with speakers are used in electronic devices such as a television receiver having a cathode-ray tube display device wherein the speakers are integrally mounted to the body of the electronic device to output voice and sound.

In addition, in recent years, television receivers having liquid crystal displays instead of cathode-ray tube displays have been used. And this enabled the bodies of the television receivers to reduce its thickness.

In such electronic devices, speakers are generally included in the bodies of the electronic devices. Thus, when the thickness of the bodies are reduced, the thickness of the speakers are also downsized and reduced considering its space, which makes it difficult to provide consumers with electronic devices capable of outputting high-quality sound because small speakers cannot suitably output high quality sound as compared with devices having relatively large speakers.

To solve this problem, Japanese Patent Laid-Open Publication No. H11-004490 (Patent Documents 1), No. H09-055990 (Patent Document 2), and H07-177592 (Patent Document 3) disclose electronic devices with separate speakers mounted outside the body of the device. For example, in Patent Document 1, speakers can be mounted outside the body of an electronic device such as a monitor by means of a speaker mounting device. The speakers are bonded to the body of the electronic device and are firmly fixed thereon with a double-sided tape to the back of the speaker mounting device. However, since the speakers are mounted outside the electronic device, wires for making connection with the electronic device had to be exposed to the outside of the back of the speakers. Another example in Patent Document 3 discloses speakers which can be readily attached/detached to/from the body of a device.

In Patent Document 1, once the speakers are mounted, it is difficult to remove the double-sided tape to detach the speakers because the speakers cannot be detached easily. For example, when the electronic device has to be moved after the speakers are mounted, the speakers and the speaker mounting device, which protrude outside the electronic device touches a wall or the like, and it was difficult to move. Further, in Patent Documents 1 to 3, wires for connecting the speakers and the electronic device which are exposed outside resulted in a poor design. Furthermore, although these external speakers can be repeatedly attached/detached to/from the electronic device, the speakers and the electronic device have to be electrically connected to each other by means of wires and terminals, which abraded a contact on a connection point and caused loose connection, resulting in failures such as the absence of sound outputted from the speakers.

### SUMMARY OF THE INVENTION

The present invention is devised in view of the problems described above and aims at providing an electronic device with external speakers, having wires stored in the electronic device which result in a fine appearance, wherein the speakers can be readily attached/detached while preventing any failures such as loose connection even when the speakers are attached/detached repeatedly.

According to the first aspect of the invention, an electronic device with an external speaker has a connecting jack for connecting the external speaker in a cabinet which form the outer shape of the body of the electronic device, in which the connecting jack and a connecting terminal provided in the external speaker are connected to each other, a locking hook formed on the external speaker is locked into a locking hole formed on the cabinet by sliding the external speaker toward the cabinet, and the speaker is detachably fixed on the cabinet, wherein either the connecting terminal or the connecting jack which are connected to each other when the external speaker is mounted, is movably guided along a sliding direction of the external speaker, and further comprising biasing means for biasing the connecting terminal or the connecting jack in the opposite direction from the sliding direction of the external speaker.

According to this arrangement, when the external speaker is fixed to the cabinet by sliding the external speaker toward the cabinet in a state in which the connecting jack and the connecting terminal are connected to each other, the connecting terminal or the connecting jack is moved according to the movement of the external speaker which prevents an excessive force from being applied to the connecting jack. Moreover, because one of the connected connecting terminal or connecting jack is pressed by the biasing means after the external speaker is fixed, it is possible to positively make the connection and prevent failures caused by loose connection of the electronic device even when the connecting terminal and the connecting jack are repeatedly attached/detached to/from each other and a gap is created by abrasion.

According to the second aspect of the invention, an electronic device with an external speaker according to the first aspect of the invention uses a spring as the biasing means.

According to this arrangement, because a spring is used for the biasing means, it is possible to positively make the connection between the connecting terminal and the connecting jack even when the connecting terminal and the connecting jack are repeatedly attached/detached to/from each other and a gap is created.

According to the third aspect of the invention, an electronic device with an external speaker according to the second aspect of the invention has the connecting jack slidably provided at the end of a guide member which is formed in the cabinet so as to be integrated with the cabinet, the spring mounted on the guide member, and the connecting jack biased by the spring in a direction orthogonal to a fitting direction to press the connecting terminal when the connecting terminal is fit into the connecting jack.

According to this arrangement, because the connecting jack is pressed by the biasing force of the spring in a direction orthogonal to a direction of connecting the connecting terminal to the connecting jack, the biasing force of the spring is operated on a fit portion of the connecting terminal and the connecting jack, and the connecting terminal can be positively held by the connecting jack.

According to the fourth aspect of the invention, an electronic device with an external speaker according to the third aspect of the invention has the connecting terminal protruding outside the body of the external speaker, and the connecting terminal connected to the connecting jack.

According to this arrangement, because the connecting terminal is connected to the connecting jack provided in the cabinet, it is possible to connect the connecting terminal to the connecting jack without exposing the constituent components provided in the body of the electronic device and the external speaker outside. Unlike an electronic device in which wires connected to the external speakers are mounted outside, the user of the device of the present invention do not have to make contact with the connected wires and can prevent breaking of wires or the like. Thus, it is possible to provide an electronic device with external speakers that is superior in design.

The electronic device with the external speaker according to the first aspect of the invention has a connecting jack for connecting the external speaker in a cabinet forming the outer shape of the body of the electronic device, in which the connecting jack and a connecting terminal provided in the external speaker are connected to each other, a locking hook formed on the external speaker is locked into a locking hole formed on the cabinet by sliding the external speaker toward the cabinet and detachably fixing the speaker on the cabinet, wherein either the connecting terminal or the connecting jack, which are connected to each other when the external speaker is mounted, is movably guided along a sliding direction of the external speaker, and further comprising biasing means for biasing the connecting terminal or the connecting jack in the opposite direction from the sliding direction of the external speaker. Hence, it is possible to simplify the connection of the connecting terminal and the connecting jack, efficiently mount the external speaker, and positively make the connection even when the connecting terminal and the connecting jack are repeatedly attached/detached to/from each other and a gap is created, thereby positively preventing failures caused by loose connection and the like.

The electronic device with the external speaker according to the second aspect of the invention has a spring as the biasing means according to the first aspect of the invention. Thus, the connection is pressed by the biasing force of the spring, thereby preventing loose connection even when the connecting terminal and the connecting jack are repeatedly attached/detached to/from each other and cause is created.

The electronic device with the external speakers according to the third aspect of the invention has the connecting jack slidably provided at the end of a guide member which is formed in the cabinet so as to be integrated with the cabinet, the spring mounted on around the guide member, and the connecting jack biased by the spring in a direction orthogonal to a fitting direction to press the connecting terminal when the connecting terminal is fit into the connecting jack according to the second aspect of the invention. Hence, the biasing force of the spring operates on a fit portion of the connecting terminal and the connecting jack, and the connecting terminal can be firmly held by the connecting jack.

The electronic device with the external speaker according to the fourth aspect of the invention has the connecting terminal protruding outside the body of the external speaker, and the connecting terminal connected to the connecting jack according to the third aspect of the invention. Since the connecting terminal is connected to the connecting jack provided in the cabinet, the user does not have to make contact with the connected wires or pull out the wires connected by soldering, which makes it possible to prevent breaking of wires or the like. Moreover, it is possible to provide an electronic device with external speakers that is superior in design.

### BRIEF DESCRIPTION OF THE DRAWINGS

FIG. 1 is a perspective view of the present invention showing a television receiver with external speakers;

FIG. 2 is a vertical sectional view of the present invention showing a television receiver with external speaker;

FIG. 3 is a vertical sectional view of the present invention showing a television receiver with external speaker detached;

FIG. 4 is a plan view of the present invention showing a television receiver with external speaker;

FIG. 5 is an explanatory drawing of the present invention showing the steps for mounting external speakers on a television receiver 10; and

FIG. 6 is a perspective view of the present invention showing a modification example in which external speakers are mounted on both sides of a television receiver.

### DETAILED DESCRIPTION OF THE PREFERRED EMBODIMENTS

Now the present invention will be described according to the preferred embodiments. Please note that the present invention can be readily applied to arrangements other than the following embodiments within the scopes of the invention.

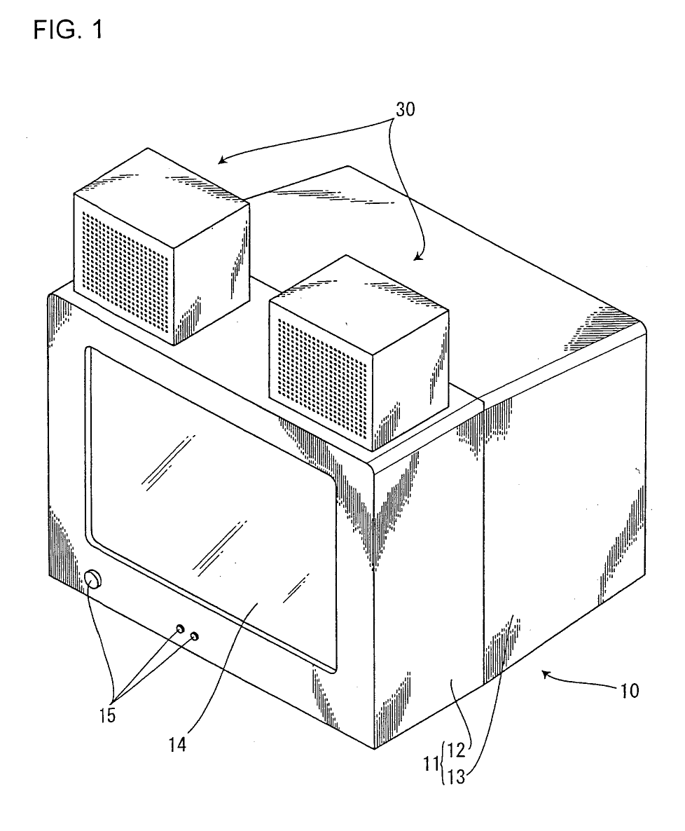

FIG. 1 shows a television receiver which is an example of an electronic device with external speakers according to the present embodiment.

A television receiver 10, which is the body of the electronic device, is entirely shaped substantially in a box shape by a front cabinet 12 and a back cabinet 13 which constitute a cabinet 11. A display part 14 for displaying an image is provided at the front side of the front cabinet 12. A plurality of operation buttons 15 are disposed below the display part 14 by which a power supply is turned on/off by operating these operation buttons 15.

A locking hole 16 and a mounting hole 18 are formed on the front cabinet 12 where the locking hole 16 serves as locking means for locking a pair of speakers (described later) and the mounting hole 18 separately provided in the rear position serves to screw a screw 17.

A long hole 19 is formed substantially in the middle between the locking hole 16 and the mounting hole 18 of the front cabinet 12 where a connector pin protruding outside the external speaker (described later) is inserted therein and fit into a connecting jack 20 comprising a concave portion provided in the cabinet 11, so that the connector pin and the connecting jack 20 can be brought into contact and electrically connected to each other.

Further, a guide member 21 is integrally formed with the front cabinet 12 having an outer shape substantially like a cylinder shape protruding inward. A strengthening rib 22 is formed surrounding one end of the guide member 21 and the connecting jack 20 for connecting the connector pin of the external speaker (described later) is disposed on the other end of the guide member 21.

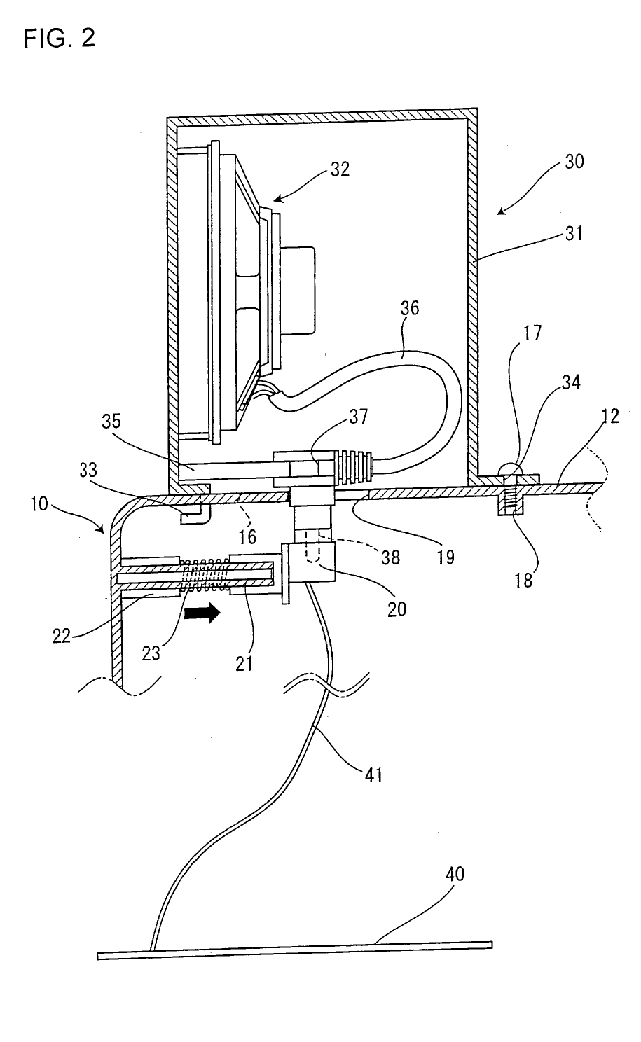

The connecting jack 20 covers the guide member 21 so as to move along in the longitudinal direction of the guide member 21 and a spring 23 serves as the biasing means for the connecting jack 20 between the connecting jack 20 and the strengthening rib 22 which is loosely fitted to the guide member 21. The connecting jack 20 is biased by the biasing force of the spring 23 in the arrow direction shown in FIG. 2, in other words, to the rear side of the external speaker.

Reference number 30 denotes the external speaker. A speaker unit 32, which converts an electric signal into sound and outputs the sound, is provided in a cabinet 31 of the external speaker 30. A locking hook 33, for locking into the locking hole 16 of the front cabinet 12, is formed at one of the lower ends of the external speaker 30 and a screw hole 34 is formed at the other lower end of the external speaker 30. The locking hook 33 is locked into the locking hole 16 by inserting into the locking hole 16 and the external speaker 30 to the front side of the front cabinet 12. Thus, the position of the screw craw 34 and the mounting hole 18 correspond and by screwing a screw 17 inserted into the screw hole 34 into the mounting hole 18, the external speaker 30 is firmly mounted into the cabinet 11.

Moreover, a support member 35 is formed in the external speaker 30 on the side of the cabinet 11 so as to be integrated with the cabinet 31 of the external speaker 30. The support member 35 horizontally stretches out to the substantial center of the speaker from the front side toward the rear side of the external speaker 30. A connecting terminal 37, which is connected to the speaker unit 32 through a wire 36 and the like, is attached to the support member 35 comprising a connector pin 38 which protrudes toward the cabinet 11 side where the external speaker 30 is mounted by repeatedly inserting/extracting the connector pin 38 to/from the connecting jack 20. Since the connector pin 38 is fit into the connecting jack 20 and is detachably connected to the connecting jack 20, the connecting terminal 37 and constituent devices including a circuit board 40 provided in the cabinet 11 of the external speaker 30 are electrically connected to each other via a wire 41 and the like in a connecting state.

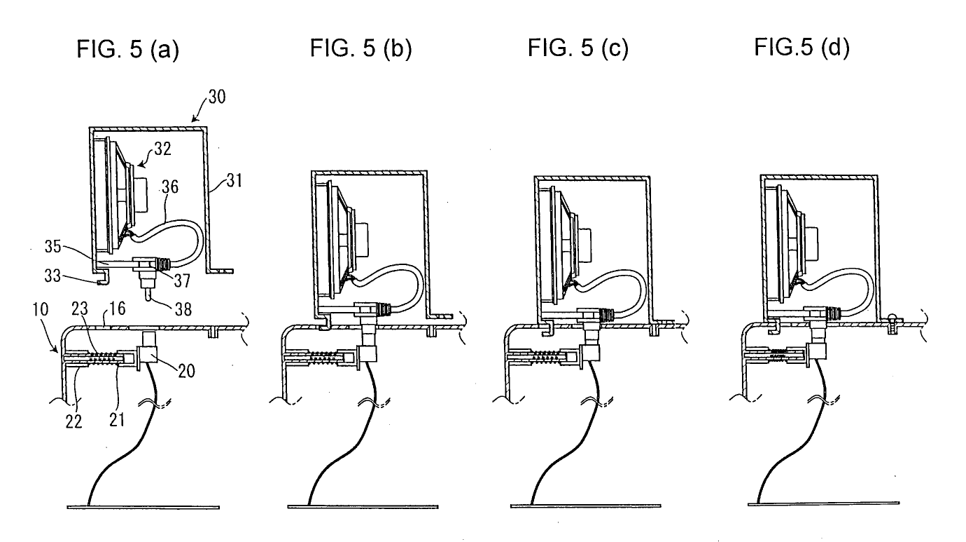

FIG. 5 is an explanatory drawing showing the steps of mounting the external speaker on the television receiver 10. Referring to FIGS. 5(a) to 5(d), the operations will be explained below.

In order to mount the external speaker 30 on the cabinet 11 of the television receiver 10, as shown in FIG. 5(a), the connector pin 38 of the external speaker 30 is moved close to the connecting jack 20. Then, as shown in FIG. 5(b), the connector pin 38 is inserted and fit into the connecting jack 20, so that an electrical connection is made.

Subsequently, as shown in FIG. 5(c), the connector pin 38 is firmly inserted into the connecting jack 20. In this electrically connected state where the connector pin 38 and the connecting jack 20 are connected, the speaker unit 32, the circuit board 40 constituting a voice circuit or the like, and devices having various functions (not shown) are connected to one another via the wires 36, 41, and the like. Thus, the user can output a sound signal or the like from the speakers by operating the operation buttons 15.

In a state in which the connector pin 38 is inserted and fit into the connecting jack 20, the connecting jack 20 is held while being biased and pressed by the biasing force of the spring 23, which serves as the biasing means, so that the connecting jack 20 is not moved. For example, it is possible to readily fit and connect the connector pin of the external speaker 30 to the connecting jack 20 of an electronic device such as the television receiver 10.

Then, as shown in FIG. 5(d), in a state in which the connector pin 38 is inserted and fit into the connecting jack 20, the locking hook 33 is engaged to the locking hole 16 by sliding the external speaker. According to this movement, the connecting jack 20 is moved together with the connector pin 38 against the biasing force of the spring 23. Then, the locking hook 33 of the external speaker 30 is locked into the locking hole 16 of the cabinet 11 and in the state where the screw hole 34 is matched with the mounting hole 18, the external speaker 30 can be firmly mounted on the television receiver 10 by means of the screw 17 or the like.

In the state in which the external speaker 30 is mounted thus on the cabinet 11 of the television receiver 10 which is an electronic device, the biasing force of the spring 23 is applied to the connector pin 38, which is fit into the connecting jack 20, in a direction orthogonal to the insertion of the connector pin 38, so that the connecting jack 20 is movably pressed and held. Since the connecting jack 20 and the connector pin 38 are pressed using the biasing force of the spring, the connecting jack 20 and the connector pin 38 are positively connected to each other. For example, the connector pin 38 is repeatedly fit and connected to the connecting jack 20, so that even when a gap appears on a fit portion due to abrasion, it is possible to avoid failures such as loose connection. Thus, it is possible to avoid failures such as the absence of sound outputted from the external speaker 30 and positively output high-quality sound.

When the external speaker 30 is detached from the television receiver 10, the external speaker 30 can be readily detached by performing the steps in the inverse order. Thus, the external speaker 30 can be repeatedly attached/detached to/from the television receiver 10.

Although the spiral spring 23 is used as the biasing means for connecting to the connecting jack 20 in the present invention, the biasing means is not limited to the spring 23. An elastic body or the like is applicable as long as the connecting jack is biased.

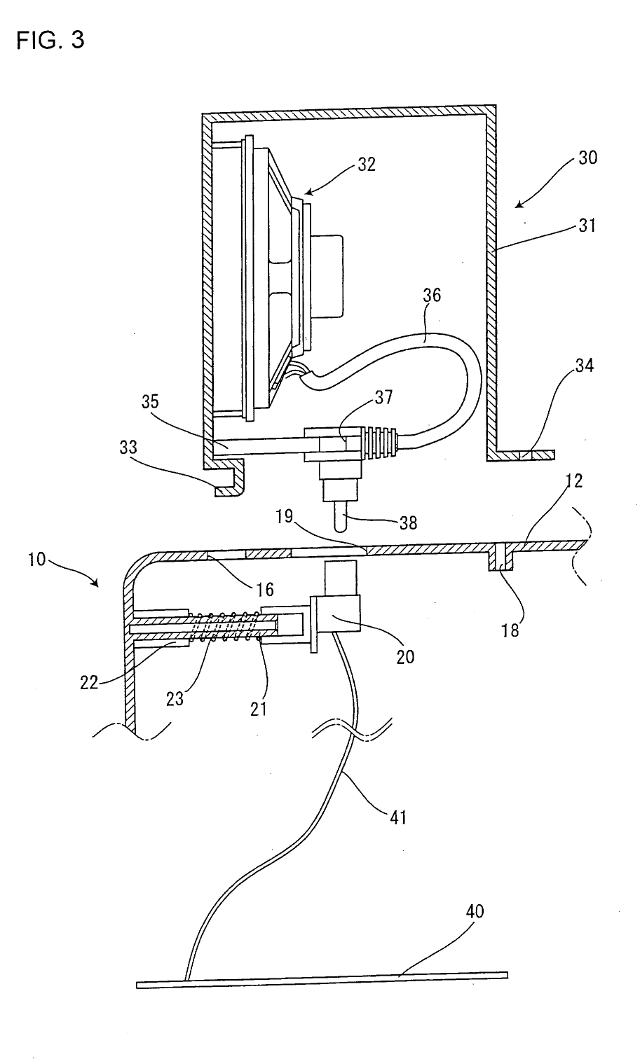

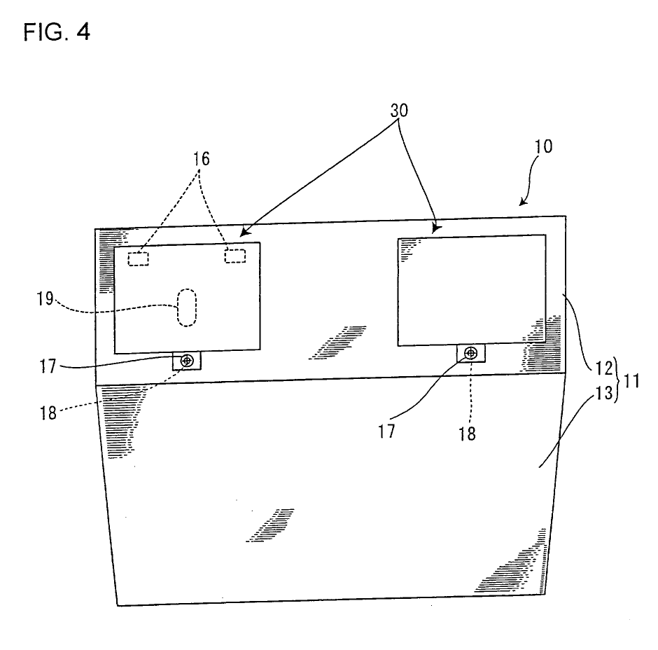

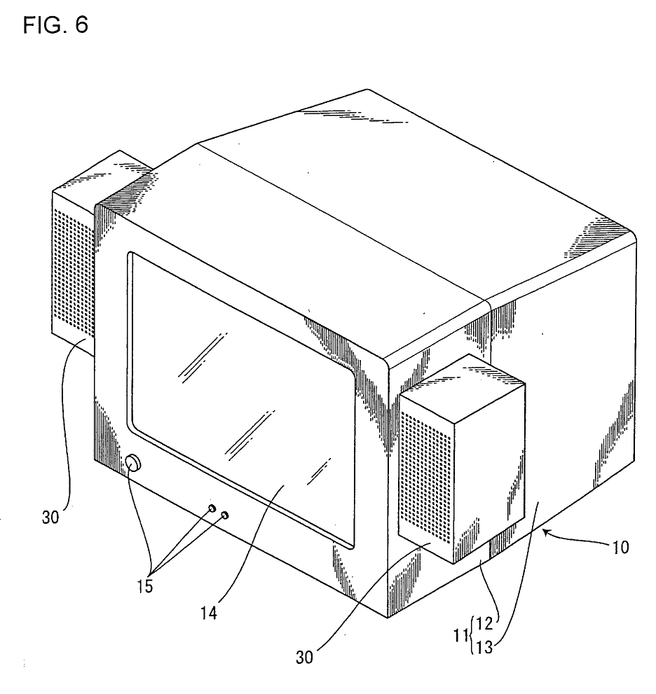

In addition, in the embodiment shown in FIGS. 1 to 5, a pair of speakers 30 are mounted on the upper face of the cabinet 11 of the television receiver 10, however, as shown in FIG. 6, the speakers 30 may be mounted respectively on both sides of the cabinet 11.

As described above, according to the electronic device with the external speaker of the present invention, the connecting jack 20 for connecting the external speaker 30 is provided in the cabinet 11 forming the outer shape of the television receiver 10 serving as the body of the electronic device, the external speaker 30 is caused to slide relatively toward the cabinet 11 in a state in which the connecting jack 20 and the connecting terminal 37 provided in the external speaker 30 are connected to each other, and the locking hook 33 formed on the external speaker 30 is locked to the locking hole 16 formed on the cabinet 11, so that the external speaker 30 is detachably fixed on the cabinet 11 wherein one of the connecting terminal 37 or the connecting jack 20, which are connected to each other when the external speaker 30 is mounted, is movably guided along the sliding direction of the external speaker 30. For example, the spring 23 is provided as the biasing means for biasing the connecting terminal 37 or the connecting jack 20 in the opposite direction from the sliding direction of the external speaker 30. Thus, when the external speaker 30 is fixed on the cabinet 11, the external speaker 30 is moved along the cabinet 11 to lock the locking hook 33 into the locking hole 16 while the locking hook 33 is inserted into the locking hole 16, so that the external speaker 30 is fixed. However, since the connecting jack 20 or the connecting terminal 37 is movably mounted along the moving direction of the external speaker 30, the connection between the connecting jack 20 and the connecting terminal 37 does not interfere with the movement of the external speaker 30. Hence, the external speaker 30 can be efficiently mounted and since excessive force is not applied to any of the connecting jack 20 and the connecting terminal 37 when the external speaker 30 is fixed, stable maintenance of the connection between the connecting jack 20 and the connecting terminal 37 are assured. Further, since one of the connected connecting terminal 37 and connecting jack 20 is pressed by the biasing means such as the spiral spring 23, it is possible to positively make the connection and prevent failures caused by loose connection of the electronic device even when the connecting terminal 37 is repeatedly attached/detached to/from the connecting jack 20 and a gap is created by abrasion.

Furthermore, the connecting jack 20 is slidably mounted on at the end of the guide member 21 which is formed in the cabinet 11 so as to be integrated with the cabinet 11, the spring 23 is mounted on the guide member 21, and the connecting jack 20 is biased by the spring 23 to press the connector pin 38 in a direction orthogonal to a fitting direction when the connector pin 38 is fit into the connecting jack 20. Thus, it is possible to stably maintain the contact between the connecting terminal 37 and the connecting jack 20 and positively connect the connecting terminal 37 and the connecting jack 20.

Moreover, the connecting terminal 37 is protruded outside the cabinet 31 of the external speaker 30, and the connecting terminal 37 protruding outside is connected to the connecting jack 20 provided in the television receiver 10. Since the connecting terminal 37 can be connected to the connecting jack 20 provided in the cabinet 11, it is possible to connect the connecting terminal 37 to the connecting jack 20 without exposing constituent components such as the wires 36 and 41, which are provided in the external speaker 30 and the television receiver 10 serving as the body of the electronic device, to the outside of the cabinet 11 and the cabinet 31. Unlike an electronic device in which wires connected to the external speaker 30 are externally mounted on the rear of the external speaker 30, for example, the user of the device of the present embodiment does not have to make contact with the wires connected to the external speaker 30 or pull out the wires connected by soldering, and therefore, it is possible to prevent broken wires and the like. Moreover, it is possible to provide an electronic device with external speakers that is superior in design.

1. An electronic device with an external speaker, having a connecting jack for connecting the external speaker in a cabinet forming an outer shape of a body of the electronic device, in which the connecting jack and a connecting terminal provided in the external speaker are connected to each other, a locking hook formed on the external speaker is locked into a locking hole formed on the cabinet by sliding the external speaker toward the cabinet, and the speaker is detachably fixed on the cabinet,
wherein either the connecting terminal or the connecting jack, which are connected to each other when the external speaker is mounted, is movably guided along a sliding direction of the external speaker, and further comprises biasing means for biasing the connecting terminal or the connecting jack in an opposite direction from a sliding direction of the external speaker.

2. The electronic device with the external speaker according to claim 1, wherein the biasing means is a spring.

3. The electronic device with the external speaker according to claim 2, wherein the connecting jack is slidably provided at an end of a guide member which is formed in the cabinet so as to be integrated with the cabinet, the spring is mounted on the guide member, and the connecting jack is biased by the spring in a direction orthogonal to a fitting direction to press the connecting terminal when a connector pin is fit into the connecting jack.

4. The electronic device with the external speaker according to claim 3, wherein the connecting terminal is protruding outside a cabinet of the external speaker and the connecting terminal is connected to the connecting jack.
